(19) United States
(12) Patent Application Publication
(10) Pub. No.: US 2009/0308192 A1
(43) Pub. Date: Dec. 17, 2009

(54) Ball screw device having bearing members of different load

(75) Inventors: Ming-Yao Lin, Taichung (TW); Wen Chia Wu, Taichung (TW)

Correspondence Address: CHARLES E. BAXLEY, ESQUIRE, 90 JOHN STREET, SUITE 309, NEW YORK, NY, 10038, US

(73) Assignee: Hiwin Technologies Corp.

(21) Appl. No.: 12/214,194

(22) Filed: Jun. 17, 2008

(51) Int. Cl. F16H 25/22

(52) U.S. Cl. 74/424.81

(57) ABSTRACT

A ball screw device includes a screw shaft engaged into a ball nut and each having helical grooves for forming two multiple turn, helical raceways, a group of rollers is received in one of the helical raceways for bearing a greater load in a forward-motion, and a group of ball bearing members is received in another helical raceway for bearing a smaller load in a backward-motion. The helical groove of the screw shaft may include a V-shaped cross section, or a flat surface at one side for engaging with the rollers, and a curved surface at another side for engaging with the ball bearing members. The ball nut may include two nut members secured together.

### BACKGROUND OF THE INVENTION

1. Field of the Invention

The present invention relates to a ball screw device, and more particularly to a ball screw device including two groups of balls or rollers or rolling or ball bearing members for resisting or bearing different loads between the nut member and the screw shaft in different directions, and for facilitating the movement between the nut member and the screw shaft.

2. Description of the Prior Art

Typical ball screw devices comprise a nut member rotatably and/or moveably engaged onto a screw shaft, and normally arranged to allow the nut member to be rotated and/or moved relative to the screw shaft in great rotational speeds. For allowing the nut member to be smoothly rotated and moved relative to the screw shaft, a suitable bearing device or lubricating structure is further required to be provided and engaged between the nut member and the screw shaft, for facilitating the rotational movement between the nut member and the screw shaft.

For example, U.S. Pat. No. 5,535,638 to Willison discloses one of the typical ball screw devices including a ball track formed by cooperating grooves in opposing flanks of the screw and nut threads, and a number of balls or bearing members provided or engaged into the ball track and engaged between the nut member and the screw shaft for facilitating the rotational movement between the nut member and the screw shaft.

However, it will be difficult to dispose or to engage the balls or bearing members into the ball track and to be engaged with the screw shaft and the nut member.

U.S. Pat. No. 6,481,305 to Nishimura et al. discloses another typical roller screw device including a number of rollers arranged in a forward-motion load roller group and a backward-motion load roller group that are separated from each other for resisting or bearing different loads between the nut member and the screw shaft in different directions, and for facilitating the movement between the nut member and the screw shaft.

Normally, the forward-motion load roller group is provided for resisting or bearing the greater loads, and the backward-motion load roller group is provided for resisting or bearing the smaller loads. However, the rollers may also have a great friction with the nut member and the screw shaft while in the backward-motion.

The present invention has arisen to mitigate and/or obviate the afore-described disadvantages of the conventional ball screw devices for such as machine tools or the like.

### SUMMARY OF THE INVENTION

The primary objective of the present invention is to provide a ball screw device including two groups of balls or rollers or rolling or ball bearing members for resisting or bearing different loads between the nut member and the screw shaft in different directions, and for facilitating the movement between the nut member and the screw shaft.

In accordance with one aspect of the invention, there is provided a ball screw device comprising a ball nut including a bore formed therein, and including an inner helical groove formed therein and communicating with the bore thereof, a screw shaft rotatably engaged into the bore of the ball nut, and including an outer helical groove formed therein for aligning with the inner helical groove of the ball nut and for forming a first multiple turn, helical raceway and at least one second multiple turn, helical raceway between the ball nut and the screw shaft, a number of rollers engaged in the first multiple turn, helical raceway for engaging between the ball nut and the screw shaft and for facilitating a movement of the ball nut relative to the screw shaft and for bearing a greater load in a forward-motion, and a number of ball bearing members engaged in the second multiple turn, helical raceway for engaging between the ball nut and the screw shaft and for facilitating the movement of the ball nut relative to the screw shaft and for bearing a smaller load in a backward-motion.

The helical groove of the screw shaft may include a V-shaped cross section, or may include a flat surface at one side for engaging with the rollers, and a curved surface at another side for engaging with the ball bearing members.

The ball nut may include a first nut member and a second nut member secured together, such as secured together with a coupler member which may be a coupler ring, or a pre-loaded coupler member.

The first nut member includes a helical groove portion of the helical groove having a flat V-shaped cross section for engaging with the rollers, and the second nut member includes a helical groove portion of the helical groove having a curved V-shaped cross section for engaging with the ball bearing members.

The first nut member and the second nut member each include at least one deflector device for forming the first and the second multiple turn, helical raceways in the first and the second nut members respectively.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a ball screw device in accordance with the present invention, in which one half of the nut member has been cut off for showing the inner structure of the ball screw device;

FIG. 2 is a partial cross sectional view of the ball screw device;

FIG. 3 is an enlarged partial cross sectional view of the ball screw device;

FIG. 4 is another enlarged partial cross sectional view of the ball screw device;

FIG. 5 is another partial cross sectional view similar to FIG. 2, illustrating the other arrangement of the ball screw device; and

FIG. 6 is an enlarged partial cross sectional view similar to FIG. 3, illustrating the further arrangement of the ball screw device.

### DETAILED DESCRIPTION OF THE PREFERRED EMBODIMENT

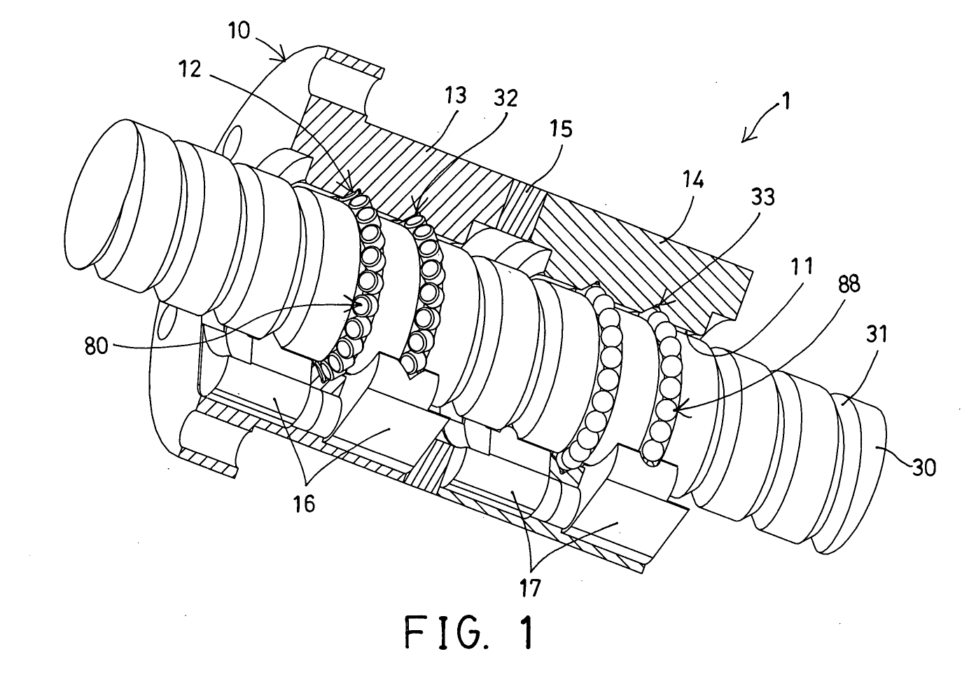

Referring to the drawings, and initially to FIGS. 1-3, a ball screw device 1 in accordance with the present invention comprises an outer ball nut 10 including a bore 11 formed therein and having an inner thread or peripheral and helical groove 12 formed therein and communicating with the bore 11 thereof for aligning with an outer thread or peripheral and helical groove 31 of a screw shaft 30 and for forming one or more (such as two) multiple turn, helical raceways 32, 33 and for rotatably and/or movably receiving one or more (such as two) groups of balls or rollers or rolling or ball bearing members 80, 88 therein which may facilitate the rotating movement of the ball nut 10 relative to the screw shaft 30 when the screw shaft 30 is forced to rotate relative to the ball nut 10 or when the ball nut 10 is forced to rotate relative to the screw shaft 30, in order to constitute the primary structure of the ball screw device 1.

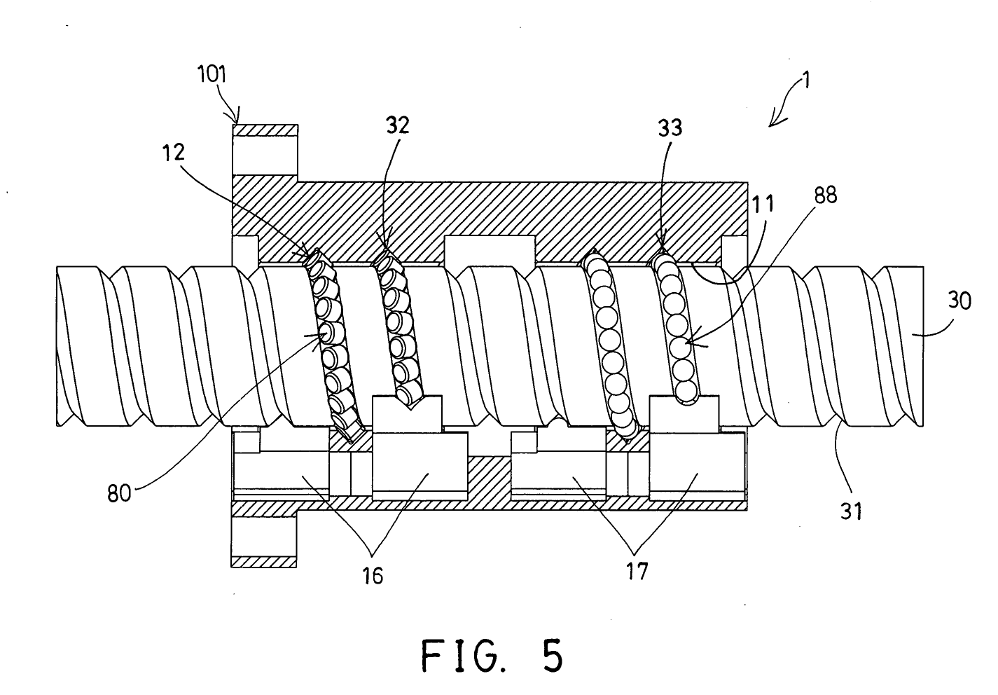

For example, the ball nut 10 includes one or more (such as two) nut members 13, 14 secured together with a pre-loaded coupler member 15, such as a coupler ring 15 for allowing the nut members 13, 14 to be secured together as a one-integral piece, and one or more (such as two) deflector devices 16, 17 attached to each of the nut members 13, 14 for forming the multiple turn, helical raceways 32, 33 in the nut members 13, 14 respectively and for rotatably and/or movably receiving the two groups of rollers 80 or ball bearing members 80, 88 respectively. It is preferable that the peripheral and helical groove 31 of the screw shaft 30 includes a V-shaped cross section. Alternatively, as shown in FIG. 5, the nut members of the ball nut 101 may also be formed as a one-integral piece, instead of two pieces that are secured together.

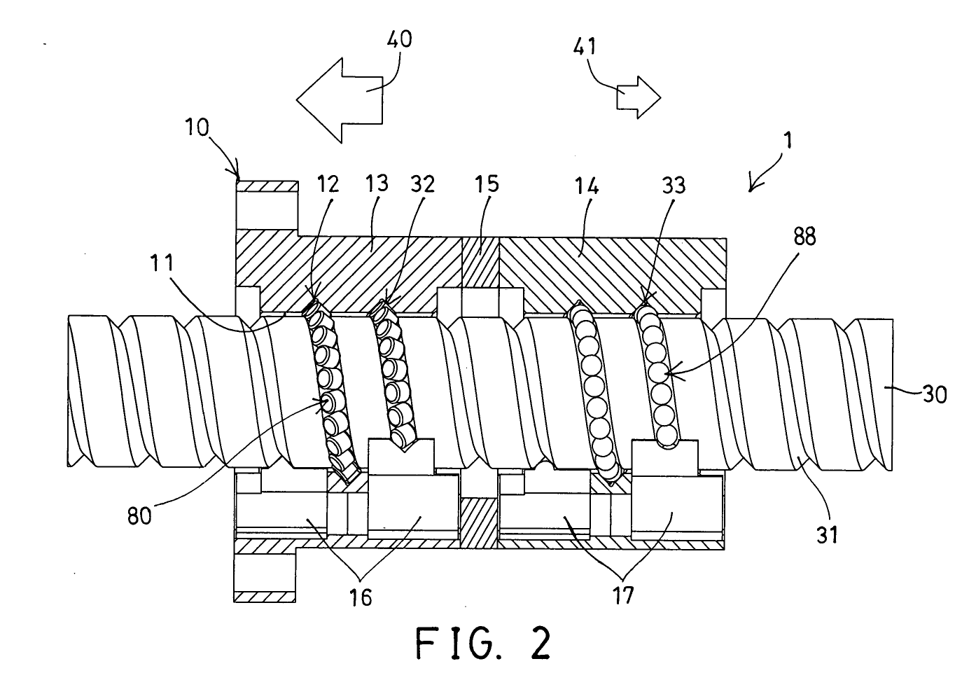

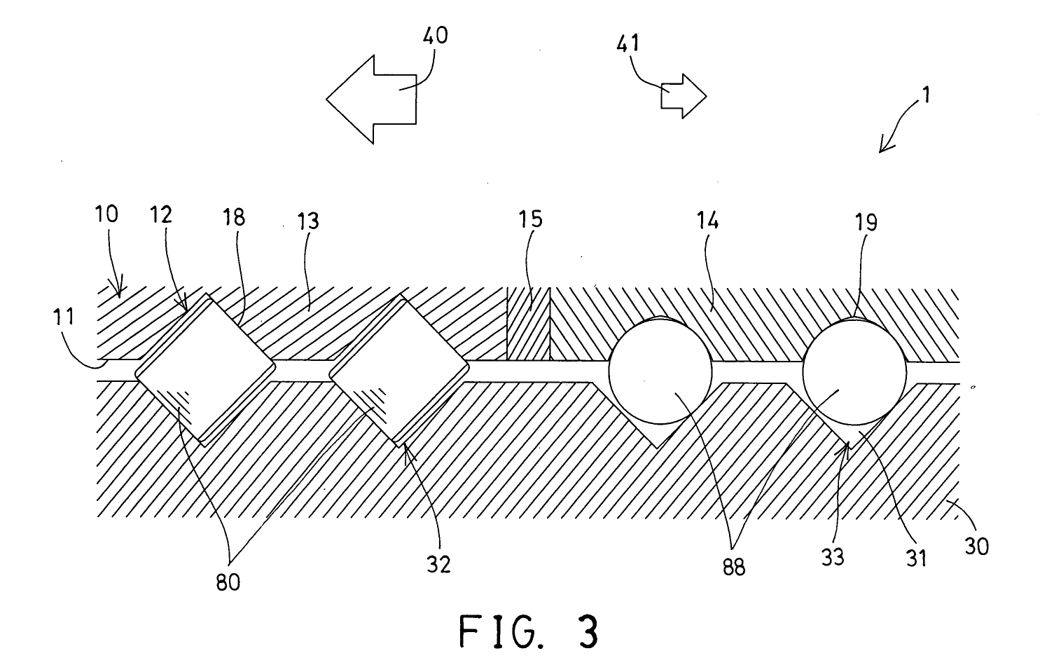

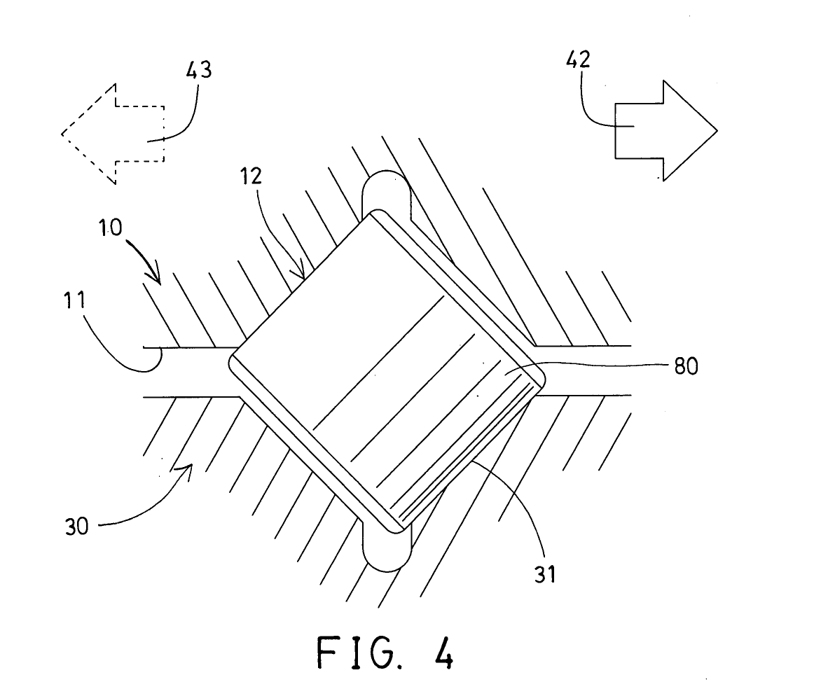

As shown in FIGS. 2, 3, the group of rollers 80 is provided for resisting or bearing the greater loads 40 in the forward-motion, and the group of ball bearing members 88 is provided for resisting or bearing the smaller loads 41 in the backward-motion. For example, as shown in FIG. 4, the single roller 80 is provided and arranged for resisting or bearing the greater load 42 in the forward-motion, but may not be provided for resisting or bearing the smaller load 43 in the backward-motion, such that the group of rollers 80 may be provided for resisting or bearing the greater loads 40 in the forward-motion.

As shown in FIG. 3, the peripheral and helical groove portion 18 of the peripheral and helical groove 12 of the nut member 13 includes a flat V-shaped cross section for suitably engaging with the rollers 80, and the peripheral and helical groove portion 19 of the peripheral and helical groove 12 of the other nut member 14 includes a curved V-shaped cross section for suitably engaging with the ball bearing members 88 and for suitably increasing the contact area between the ball bearing members 88 and the nut member 14 and for facilitating the movement between the nut member 14 and the screw shaft 30. The typical ball screw devices failed to provide a group of rollers 80 for resisting or bearing the greater loads 40 in the forward-motion, and simultaneously a group of ball bearing members 88 for resisting or bearing the smaller loads 41 in the backward-motion.

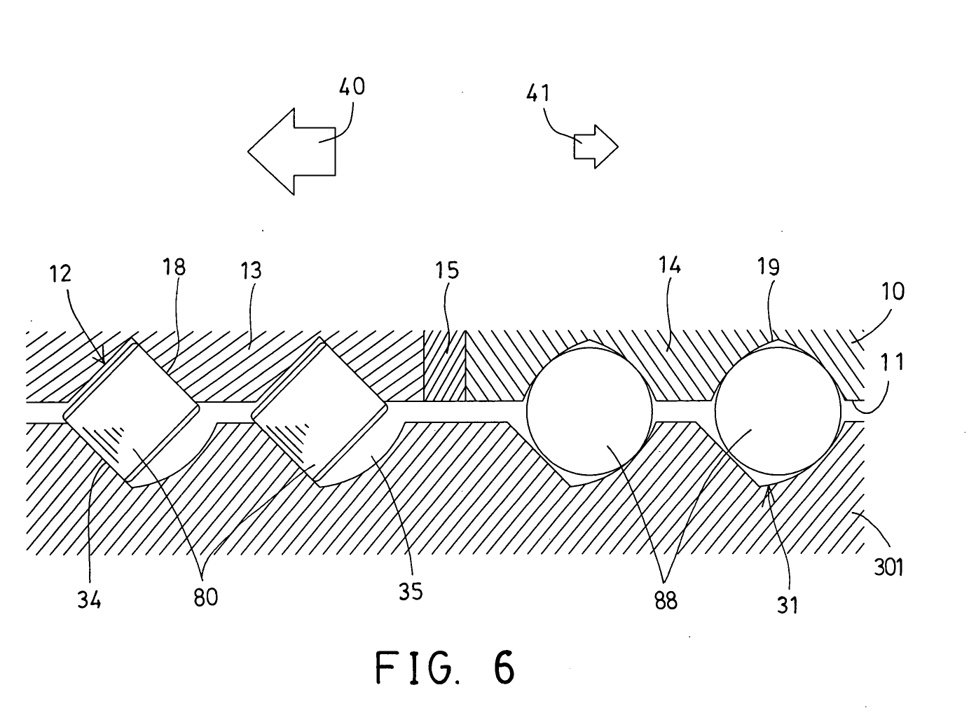

Alternatively, as shown in FIG. 6, the peripheral and helical groove 31 of the screw shaft 30 may include a flat surface 34 at one side for suitably engaging with the rollers 80, and a curved surface 35 at the other side for suitably engaging with the ball bearing members 88 and for suitably increasing the contact area between the ball bearing members 88 and the screw shaft 30.

Accordingly, the ball screw device in accordance with the present invention includes two groups of balls or rollers or rolling or ball bearing members for resisting or bearing different loads between the nut member and the screw shaft in different directions, and for facilitating the movement between the nut member and the screw shaft.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A ball screw device comprising:
a ball nut including a bore formed therein, and including an inner helical groove formed therein and communicating with said bore thereof,
a screw shaft rotatably engaged into said bore of said ball nut, and including an outer helical groove formed therein for aligning with said inner helical groove of said ball nut and for forming a first multiple turn, helical raceway and at least one second multiple turn, helical raceway between said ball nut and said screw shaft,
a plurality of rollers engaged in said first multiple turn, helical raceway for engaging between said ball nut and said screw shaft and for facilitating a movement of said ball nut relative to said screw shaft and for bearing a greater load in a forward-motion, and
a plurality of ball bearing members engaged in said at least one second multiple turn, helical raceway for engaging between said ball nut and said screw shaft and for facilitating the movement of said ball nut relative to said screw shaft and for bearing a smaller load in a backward-motion.

2. The ball screw device as claimed in claim 1, wherein said helical groove of said screw shaft includes a V-shaped cross section.

3. The ball screw device as claimed in claim 1, wherein said ball nut includes a first nut member and a second nut member secured together.

4. The ball screw device as claimed in claim 3, wherein said first nut member and said second nut member of said ball nut are secured together with a coupler member.

5. The ball screw device as claimed in claim 4, wherein said coupler member is a coupler ring.

6. The ball screw device as claimed in claim 4, wherein said coupler member is a pre-loaded coupler member.

7. The ball screw device as claimed in claim 3, wherein said first nut member includes a helical groove portion of said helical groove having a flat V-shaped cross section for engaging with said rollers.

8. The ball screw device as claimed in claim 3, wherein said second nut member includes a helical groove portion of said helical groove having a curved V-shaped cross section for engaging with said ball bearing members.

9. The ball screw device as claimed in claim 3, wherein said first nut member and said second nut member each include at least one deflector device for forming said first and said at least one second multiple turn, helical raceways in said first and said second nut members respectively.

10. The ball screw device as claimed in claim 1, wherein said helical groove of said screw shaft includes a flat surface at one side for engaging with said rollers, and a curved surface at another side for engaging with said ball bearing members.
